(19) United States
(12) Patent Application Publication
(10) Pub. No.: US 2006/0011519 A1
(43) Pub. Date: Jan. 19, 2006

(54) Systems and methods for material handling

(75) Inventors: Joseph F. McCleary, Centennial, CO (US); Mark Tiedeman, Aurora, CO (US)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(73) Assignee: Colorado Golf Innovations, LLC, Aurora, CO (US)

(21) Appl. No.: 11/165,420

(22) Filed: Jun. 22, 2005

Related U.S. Application Data
(60) Provisional application No. 60/586,301, filed on Jul. 8, 2004.

(51) Int. Cl. B07B 13/16

(52) U.S. Cl. 209/247

(57) ABSTRACT

Various systems and methods for material sorting are described. As one example, a system for sorting materials is described that includes a material handler mounting component that is tailored for connection to a material handler. In addition, the system includes a cross conveyor that is connected to the material handler mounting component. An elevation adjustment device is connected to the cross conveyor, and is operable to allow modification of the elevation of a first end of the cross conveyor in relation to the elevation of a second end of the cross conveyor. A processing device is also attached to the cross conveyor near one end of the cross conveyor.

### CROSS REFERENCE TO RELATED APPLICATIONS

The present application claims priority to U.S. Provisional Patent Application No. 60/586,301, filed Jul. 8, 2004. The entirety of the aforementioned application is incorporated herein by reference for all purposes.

### BACKGROUND OF THE INVENTION

The present inventions are generally related to agricultural machinery and more particularly to systems and methods for processing materials.

Various maintenance operations utilized on turfgrass sites can require processed materials to be a particle size that can be suitable for topdressing and other maintenance operations. In order to be suitable for topdressing, processed topdressing materials should have large stones and large aggregate material removed. Removing these materials can allow topdressing materials to be incorporated into the turfgrass stand in a manner that can be consistent with practices utilized on golf courses, sports fields, and other turfgrass facilities. Screened and/or processed soil and compost material that can be purchased from suppliers may not meet a topdressing particle size requirement established by a specific turfgrass facility, so additional processing at a turfgrass facility may be required to produce a material with a desirable topdressing particle size. If stones and other large aggregate materials are not removed from topdressing materials, mowing machinery may be damaged by stones and large aggregate materials, additional labor may be required to remove these materials from topdressed turfgrass sites prior to mowing and utilization, and other adverse operational impacts may occur.

Hence, for at least the aforementioned reasons, there exists a need in the art for advanced systems and methods for material processing.

### BRIEF SUMMARY OF THE INVENTION

The present inventions are generally related to agricultural machinery and more particularly to systems and methods for processing materials.

The present invention provides various systems and methods for material sorting. In particular, various embodiments of the present invention provide systems for sorting materials that include a material handler mounting component that is tailored for connection to a material handler. In addition, the system includes a cross conveyor that is connected to the material handler mounting component. An elevation adjustment device is connected to the cross conveyor, and is operable to allow modification of the elevation of a first end of the cross conveyor in relation to the elevation of a second end of the cross conveyor. A processing device is also attached to the cross conveyor near one end of the cross conveyor.

In some cases, the system further includes a material handler. Such a material handler can be, but is not limited to, a manure spreader, a soil spreader or a gravel spreader. Based on the disclosure provided herein, one of ordinary skill in the art will recognize a variety of material handlers that may be used in association with one or more embodiments of the present invention.

In some instances of the embodiments, the processing device includes a rectangular box associated with a pivoting fence. The pivoting fence includes at least one pivot section, and in some cases five or more pivot sections. The pivot section(s) and/or the rectangular box may be formed of steel or some other suitable material. Further, in some cases, the pivot section(s) may include an upper pivot section and a lower pivot section. The lower pivot section may be adjustable such that a space between the lower pivot section and a conveyor belt associated with the cross conveyor may be adjusted.

Yet other instances of the embodiments include a discharge regulator attached to the cross conveyor near the second end of the cross conveyor. In some instances, the system further comprises a power connector that is operable to draw power from the material handler for operation of one or more elements of the system. The power connector may be any type of connector or connection capable of drawing power from the material handler to be used in operating the system. Thus, as just one example, the power connector may be, but is not limited to, a hydraulic connector. Based on the disclosure provided herein, one of ordinary skill in the art will recognize a variety of other power connectors that may be used in accordance with one or more embodiments of the present invention. In one or more instances of the embodiments, a patterned conveyor belt is associated with the cross-conveyor.

Other embodiments of the present invention provide methods for retrofitting material handling equipment. The methods include providing a cross-conveyor and a processing device. In addition, the methods include replacing a smooth belt associated with the cross-conveyor with a patterned cross-conveyor belt, and attaching the processing device to the cross-conveyor. In particular instances of the embodiments, the methods further include attaching the cross-conveyor to a material handler. In some cases, the processing device includes a rectangular box, and a pivoting fence that includes a plurality of pivot sections.

Yet other embodiments of the present invention provide systems for soil processing that include a cross-conveyor with a conveyor belt supported by a cross-conveyor frame. In addition, the systems include a swivel kit that is operable to attach the cross-conveyor to a material handler. In one or more cases, the swivel kit includes a funnel operable to receive material from a material handler and transfer the material to the conveyor belt. The systems further include a processing device that is attached to the cross-conveyor near an end of the cross-conveyor. This processing device is operable to eliminate large particles from the material. In some instances of the embodiments, the system further includes an elevation adjustment device that is connected to the cross-conveyor. The elevation adjustment device is operable to allow modification of the elevation of one end of the cross-conveyor in relation to an opposite end of the cross-conveyor.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a perspective view of a material sorting system in accordance with one or more embodiments of the present invention, and shown in relation to a material handler;

FIG. 2A is a perspective view of a processing component in accordance with some embodiments of the present invention;

FIG. 2B is a top view of the processing component of FIG. 2A;

FIG. 2C is a side view of the processing component of FIG. 2A;

FIG. 2D is a front view of the processing component of FIG. 2A showing detail of a fence in accordance with one or more embodiments of the present invention;

FIG. 2E is a detailed rear view of a fence section associated with the fence of FIG. 2D;

FIG. 2F is a side view of the fence section of FIG. 2E showing a vertically adjustable lower fence section and a pivoting upper fence section in accordance with some embodiments of this present invention;

FIG. 3A is a view of an incline component, including a material handler attachment frame, a cross conveyor attachment frame, elevation adjustment rods, and an elevation pivot block in accordance with some embodiments of this present invention;

FIG. 3B is a view of the incline component of FIG. 3A

FIG. 3C is a side view of the incline component of FIG. 3A;

FIG. 3D is a bottom view of a cross conveyor attachment frame associated with the incline component of FIG. 3A, and in accordance with one or more embodiments of the present invention;

FIG. 3E is an end view of the incline component of FIG. 3A showing a material handler attachment frame and a cross conveyor attachment frame in accordance with some embodiments of the present invention;

FIG. 4A is a top view of a discharge regulator in accordance with some embodiments of this present invention;

FIG. 4B is an end view of the discharge regulator of FIG. 4A; and

FIG. 4C is a side view of the discharge regulator of FIG. 4A.

### DETAILED DESCRIPTION OF THE INVENTION

The present invention is generally related to agricultural machinery and more particularly to systems and methods for processing materials.

Some embodiments of the present invention provide systems and methods for processing soil, compost and other materials that can be used on turfgrass sites and other similar areas, including but not limited to golf courses and athletic fields. Such embodiments of the present invention may be accomplished in relation to a material handler, a cross conveyor and various other machinery that can be typically found in an equipment fleet at a golf course, athletic field or other large turfgrass facilities. Since these operations typically have this equipment, such embodiments of the present invention can offer systems and methods for processing materials that can create an additional use for equipment and can eliminate the need to purchase another additional piece of machinery, so a financial benefit can be generated. Such embodiments can provide systems and methods that can be utilized to process soils and organic waste materials generated at a golf course, athletic field or other large turfgrass maintenance facilities. These facilities may generate these wastes and may have a desire to process these wastes in a manner that may allow them to be used and not removed for disposal. Thus, such embodiments of the present invention can provide systems and methods for processing these wastes into materials suitable for use. As previously suggested, various embodiments of the present invention provide systems and methods that can be attached to other pieces of equipment and that can utilize power that can be generated by another piece of equipment. In some cases, systems provided herein do not include their own power source, but rather rely on another power source to operate. Based on the disclosure provided herein, one of ordinary skill in the art will also recognize that systems in accordance with the present invention may also be made with an incorporated power source.

In particular situations, one or more embodiments of the present invention may be used for processing soil, removing rocks and debris from bunker sand, processing aeration cores, processing compost materials, and processing numerous other types of materials that can be used and generated by large turf maintenance operations (golf course, sports fields, parks, etc.). Such embodiments of the present invention may be implemented in relation to a cross conveyor attached to a material handler equipped with a swivel kit. The swivel kit may be that available from one or more manufacturers and marketed under the brand names Ty-Crop, Dakota Peat, and Turfco. For example, the swivel kit may be, but is not limited to, a Ty-Crop swivel kit part #36002200 or a Turfco swivel kit part #86149. Similarly, various embodiments of the present invention may utilize commercially available material handlers and/or cross-conveyors including, but not limited to, a Ty-Crop material handler MH400 part #36001000 and/or cross conveyor part #36002002, a Turfco material handler is CR10 part #85440 and/or cross conveyor part #86147, Dakota Peat material handler Turf Tender 440 part #C4401 and/or side conveyor part #C44070, or some other combination thereof. When used to attach a cross conveyor to a material handler equipped with a swivel kit, various embodiments of the present invention may provide an economical apparatus for processing and recycling byproducts generated by a large turf maintenance operation that typically are disposed in landfills.

In other situations, embodiments of the present invention can be used with a cross conveyor equipped material handler that can be hydraulically powered by a tractor or another piece of machinery capable of operating a material handler. Material suitable for processing can be placed in a material handler's main hopper and transported from the bottom of a material handler's hopper via a material handler's main conveyor belt that can form a movable floor in a material handler. Material transported by a main conveyor belt can be discharged through a swivel kit at an end of a material handler's main conveyor belt onto a cross conveyor. Typically, cross conveyors utilize smooth rubber belts to transport and discharge material out an end of a cross conveyor, however, performance of these present inventions can be enhanced if a cross conveyor's smooth, rubber belt can be changed to a belt that can be constructed of rubber and that can have a pattern capable of transporting and regulating soil particle size.

In some cases, before material is deposited onto a cross conveyor, one or more embodiments of the present inventions may be utilized to attach a cross conveyor to a material handler. Such embodiments may include an incline component that can enable a cross conveyor to be positioned in numerous inclined operating positions that can be greater than an incline originally created when a cross conveyor is conventionally attached to a material handler equipped with a swivel kit. A patterned rubber belt that can replace a cross conveyor's manufacturer installed, smooth, rubber belt can increase the amount of material that can be transported up an adjusted incline of a cross conveyor and can influence the particle size of material processed by these present inventions. A patterned rubber, replacement belt on a cross conveyor can transport material to a location where a processing component that can include a plurality of adjustable, individual pivoting, tensioned fences can be attached to a cross conveyor. A processing component in conjunction with an altered elevation of a cross conveyor created by an incline component and a patterned belt can create a churning action at a processing component and a discharge component that can reduce the particle size of unprocessed material deposited in a material handler. A processing component's fence sections can regulate the particle size of a final product that can be discharged from an end of a cross conveyor.

In some cases, large, waste material restricted by a processing component's fence sections can fall down an inclined cross conveyor away from a processing component and can accumulate against a discharge component that can be located at the lowest point on an inclined cross conveyor. Accumulated waste material can be released from this point by raising a discharge component that can include a section of flat rubber and can attach to a cross conveyor. A discharge component can allow waste material to fall to the ground from a cross conveyor and waste material can accumulate in a pile separate from a pile of processed soil.

Some embodiments of the present invention provide various structural features that can make the mounting of the embodiment onto a cross conveyor and a material handler equipped with a swivel kit possible. The mounting can include, but is not necessarily limited to, attaching an incline component, a discharge regulator, and a patterned belt to a cross conveyor. In addition, a processing component may be attached. Such a processing component can include a frame, shaft, springs, adjustment rods, a plurality of pivoting fence sections, a fence stop, and mounting tabs. The incline component can include a material handler attachment frame, a shaft, elevation adjustment rods, a pivot block, leveling stops, and a cross conveyor attachment frame. The discharge regulator can include a frame and rubber section. A patterned belt can replace smooth belts typically utilized on cross conveyors and can transport material to a location on a cross conveyor where a processing component can be attached to a cross conveyor.

In one particular instance of the embodiments, an incline component may be included that is constructed of welded steel and can include a material handler attachment frame, a cross conveyor attachment frame, a shaft, elevation adjustment rods, and an elevation pivot block. In such instances, the material handler attachment frame can be rectangular, can be designed to attach an incline component to a material handler, can be constructed from welded steel, can include two steel leveling stops with rubber bumpers, can include two steel blocks that can provide a pivot point that can link a material handler attachment frame to a shaft, can include four steel pieces welded to a material handler attachment frame that link it to elevation adjustment rods. The cross conveyor attachment frame can be rectangular, can be constructed from welded steel, can be used to attach an incline component to a cross conveyor, and can include two steel blocks that can provide a pivot point that can link a cross conveyor attachment frame to a shaft. A shaft can be constructed from steel and can link a material handler frame to a cross conveyor frame. Elevation adjustment rods can be constructed from steel, can include two steel rods, and can link a material handler frame to an elevation pivot block. An elevation pivot block can be constructed of steel, can regulate an incline created by elevation rods, can provide a link between elevation rods and an elevation pivot block, and can provide an attachment point between an incline component and a cross conveyor. Based on the disclosure provided herein, one of ordinary skill in the art will appreciate other configurations for the aforementioned components in accordance with other embodiments of the present invention.

In the same instance, the processing component can be constructed of steel, can include a rectangular box, can include a pivoting fence, and can include a shaft. The rectangular box can be welded steel, can attach a processing component to a cross conveyor, can include two angled steel pieces that can direct material into a fence, can include four steel mounting brackets, can include a piece of steel that can provide alignment for a fence, and can provide a mounting location for a processing component's steel shaft. The pivoting fence can include numerous individual pivoting steel sections, can include vertically adjustable lower fence sections that can be bolted to pivoting upper fence sections, can include spring loaded adjustment rods that can attach pivoting steel sections to a rectangular box, can include pieces of steel welded to pivoting steel sections that can regulate the vertical position of a fence, and can provide a pivot point between pivoting steel sections and a shaft. A shaft can be constructed of steel and can provide a link between a rectangular box and a fence. The discharge component can be welded steel, can attach to a cross conveyor, can include a section of rubber, and can include two arms that rest on a cross conveyor. Again, based on the disclosure provided herein, one of ordinary skill in the art will appreciate other configurations for the aforementioned components in accordance with other embodiments of the present invention.

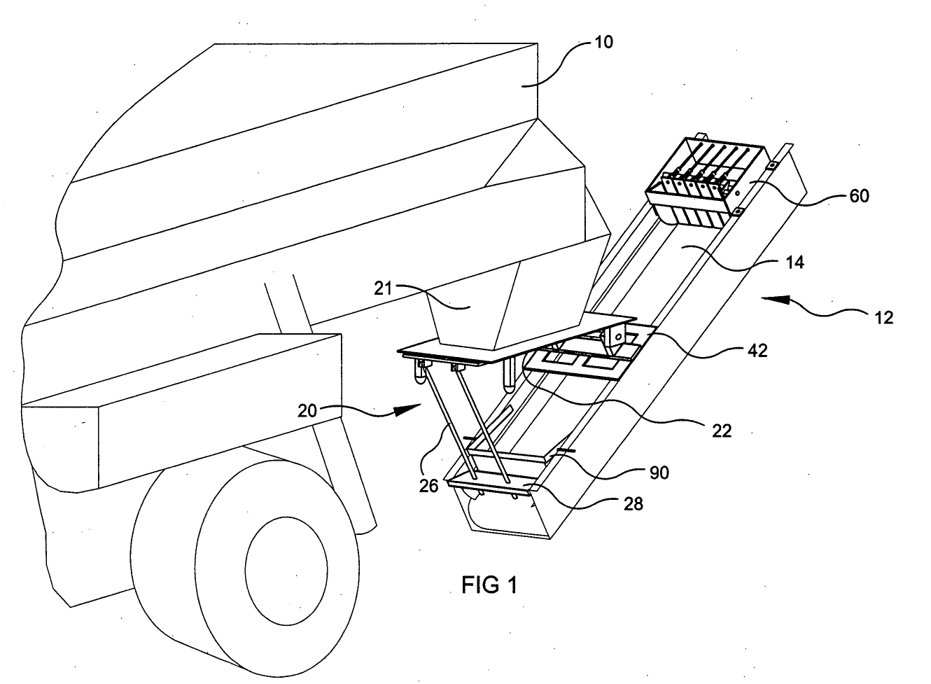

An exemplary preferred embodiment of a present invention is illustrated in FIGS. 1-4. FIG. 1 shows a processing component 60 that can be attached to a cross conveyor 12. A cross conveyor attachment frame 42 can be attached to a cross conveyor 12. A discharge regulator 90 can be attached to a cross conveyor 12. An elevation pivot block 28 can be attached to a cross conveyor 12. A patterned cross conveyor belt 14 in a cross conveyor 12. Patterned cross conveyor belt 14 can be a rubber, patterned belt that can be used to replace a manufacturer provided, smooth rubber belt typically utilized on a cross conveyor 12. A material handler attachment frame 22 can be attached to a material handler 10 equipped with a swivel kit 21. Elevation adjustment rods 26 can connect an elevation pivot block 28 to a material handler attachment frame 22. An incline component 20 can include a material handler attachment frame 22, elevation adjustment rods 26, an elevation pivot block 28, and a cross conveyor attachment frame 42.

In general, material can be placed in the material handler 10 and then a material handler's belt transports the material to a location at an end of the material handler's belt where the material can fall through a swivel kit 21. Swivel kit 21 can direct the material as it falls onto a patterned conveyor belt 14 that can be located on a cross conveyor 12. An operational inclined position for cross conveyor 12 can be established with incline component 20. Patterned conveyor belt 14 can transport the material up an inclined cross conveyor 12 where the material encounters a processing component 60. When the material encounters a fence associated with processing component 60, large particles can be processed to a particle size that can pass beyond processing component 60 into a pile of processed material. Alternatively, waste material that cannot be processed by processing component 60 can fall down patterned replacement belt 14 and can be discharged into a waste pile when discharge regulator 90 is raised.

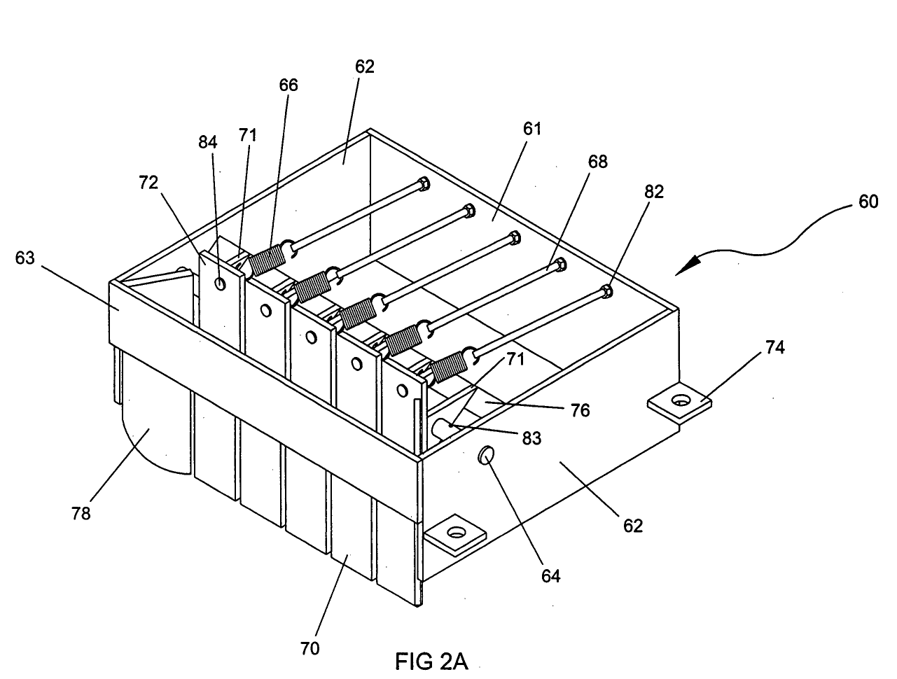

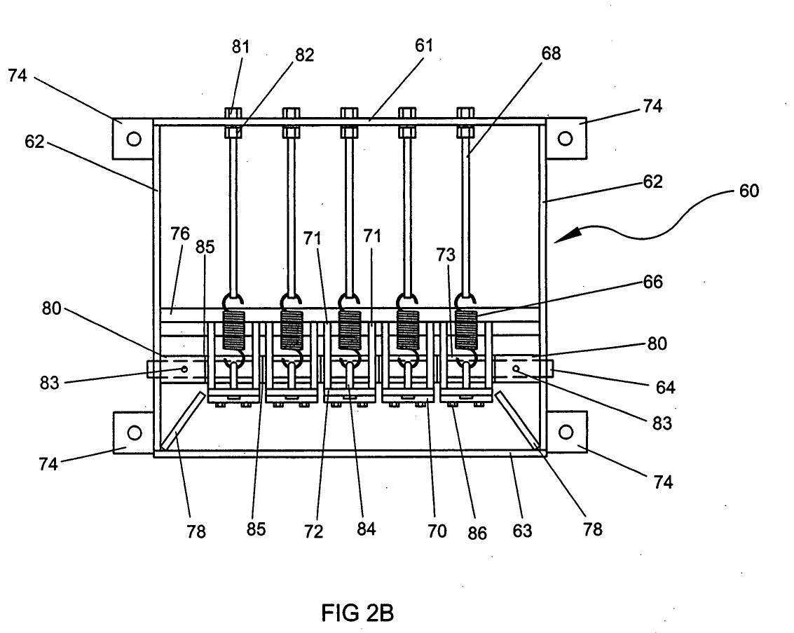

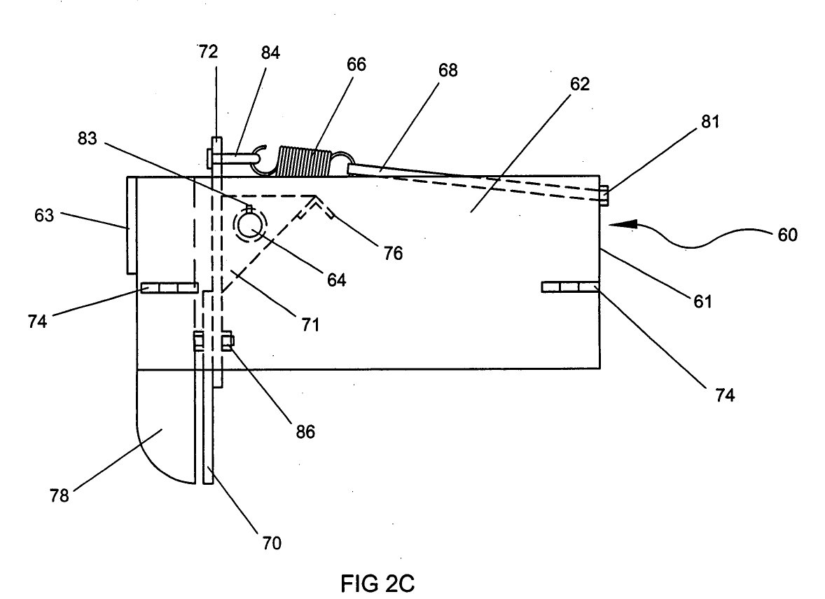

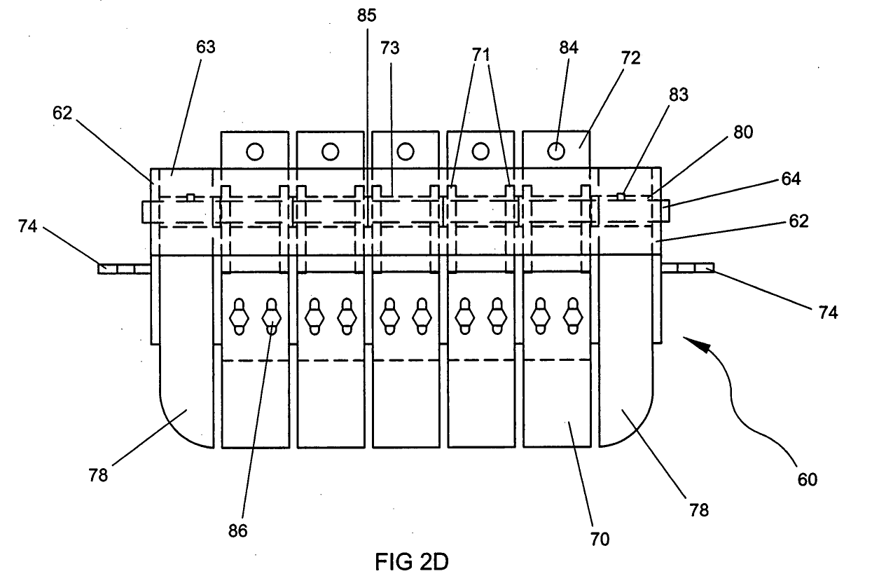

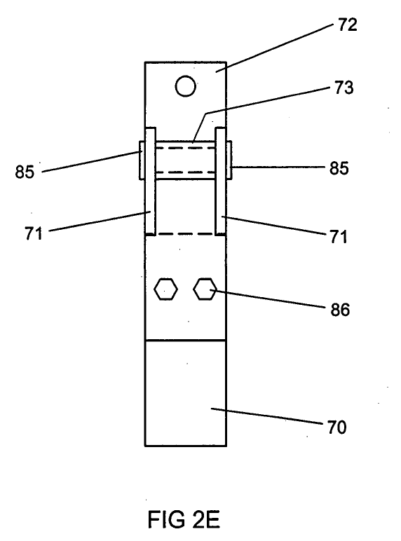

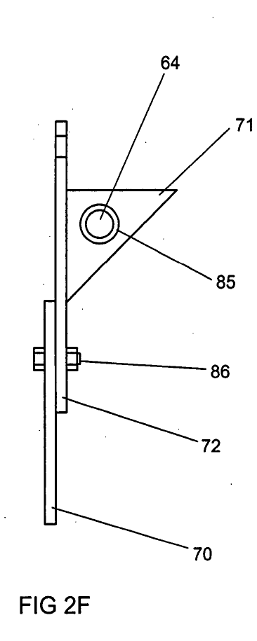

FIG. 2A is a perspective view of a processing component 60 in accordance with some embodiments of these present invention. In general, processing component 60 provides an operational method for excluding large particles from inclusion in processed material. In one particular case of the exemplary embodiment, processing component 60 can have a rectangular shape that can be created by welding together processing component frame sides 62, a processing component frame front 63 and a processing component frame back 61. Mounting tabs 74 can be welded perpendicular to processing component frame sides 62. Angle plates 78 can extend below processing component frame sides 62. A fence stop 76 can be welded perpendicular to a processing component frame sides 62. A processing component shaft 64 can penetrate through processing component frame sides 62 and can be secured in place with set screws 83. A vertically adjustable lower fence section 70 can be attached to the front of a pivoting upper fence section 72. Clevis pins 84 can be inserted through holes in pivoting upper fence sections 72 and can be connected to a spring 66 that can connect to an adjustment rod 68 that can penetrate a processing component frame back 61 through a hole and can be secured with a nut 81 (shown in other views of FIG. 2) and a nut 82. Based on the disclosure provided herein, one of ordinary skill in the art will recognize that other dimensions, features, shapes, and/or constructions may be utilized to develop the aforementioned components in accordance with one or more embodiments of the present invention.

FIG. 2B shows a top view of processing component 60 in accordance with some embodiments of these present invention. In general, processing component 60 may provide an operational method for excluding large particles from inclusion in processed material. In one particular case of these exemplary embodiments, processing component 60 can have a rectangular shape that can include processing component frame sides 62 that can be constructed with 0.25 inch steel that can be 12.5 inches wide and can be 5 inches high, a processing component frame front 63 that can be constructed with 0.25 inch steel that can be 14.75 inches wide and can be 2.5 inches high, and a processing component frame back 61 that can be constructed with 0.25 inch steel that can be 14.75 inches wide and can be 5 inches high. Processing component sides 62 and a processing component frame front 63 and a processing component back 61 can be welded together to create a rectangular frame for a processing component 60. Mounting tabs 74 can be welded perpendicular to processing component frame side 62. Mounting tabs 74 that can be constructed with 0.25 inch steel that can be 1.5 inches by 1.5 inches and can have a 0.39 inch diameter hole in the center. Mounting tabs 74 can be welded at the ends of processing component frame sides 62 and 3 inches from the top of processing component frame sides 62. Mounting tabs 74 can provide a location to bolt a processing component 60 to a cross conveyor 12. Shaft collars 80 can be welded perpendicular to processing component frame sides 62. Shaft collars 80 can be constructed using a 2 inch piece of 0.625 inch round steel tubing that can have a 0.25 inch wall thickness. Angle plates 78 can be welded at a 53 degree angle or another suitable angle in corners created by processing component frame front 63 and processing component frame sides 62. Angle plates 78 can be constructed with 0.25 inch thick steel that can be 2.5 inches wide and can be 8 inches tall and can include a radius of 1.625 inches on the outside, bottom edge. Fence stop 76 can be welded perpendicular to processing component frame sides 62. Fence stop 76 can be constructed with 0.75 inch steel angle iron that can be 14.25 inches wide. Fence stop 76 can be welded in an orientation that can allow the sides of a fence stop 76 to be positioned in a manner that can create a 45 degree angle relative to the top of a processing component 60 and can be welded to processing component frame sides 62 in a location that can be 5 inches from a processing component frame front 63. Processing component shaft 64 can be inserted through processing component frame sides 62 and shaft collars 80 and pivoting upper fence section sleeves 73 and bushings 85. Processing component shaft 64 can be constructed using 0.625 inch round steel that can be 15 inches long. Bushings 85 can be flanged bushings that can have a 0.062 inch bushing thickness and a 0.093 inch flange thickness. Processing component shaft 64 can be secured in place with set screws 83 that can be located in shaft collars 80. Vertically adjustable lower fence sections 70 can be constructed with 0.25 inch thick steel that can be 2 inches wide and can be 4.875 inches high and can have two slots that can be 0.266 inch wide by 1.25 inches high and that can be located 1.5 inches from the top and 0.5 inch from the sides. Pivoting upper fence sections 72 can be constructed with 0.25 inch thick steel that can be 2 inches wide and can be 6.5 inches high and can have two 0.266 inch holes 0.75 inch from the bottom and 0.5 inch from the sides. Nuts and bolts 86 can secure an adjustable lower fence section 70 to a pivoting upper fence section 72 by means of two 0.266 inch by 1.25 inch slots that can be located in a vertically adjustable lower fence section 70 and two 0.266 inch holes that can be located in a pivoting upper fence section 72. Pivoting upper fence section stops 71 can be constructed with 0.25 inch thick steel that can be shaped like an isosceles triangle with 2.5 inch long sides and a 1 inch hole that can be located 0.75 inch from a side. One 2.5 inch side of a pivoting upper fence section stop 71 can be welded to a pivoting upper fence section 72 so the other 2.5 inch side of this pivoting upper fence section stop 71 can be perpendicular to a pivoting upper fence section 72. Pivoting upper fence section sleeves 73 can be 2 inches wide and can be constructed with 1 inch round steel tubing that can have a wall thickness of 0.125 inch can be inserted into 1.0 inch holes in pivoting upper fence section stops 71 and can be secured with a weld. Bushings 85 can be inserted into ends of pivoting upper fence section sleeves 73. Clevis pins 84 can be 0.312 by 1.0 inch and can be inserted through a 0.343 inch hole in pivoting upper fence sections 72. Springs 66 can be 0.75 inch in diameter and can be 2.5 inches long and can be connected to clevis pins 84 and adjustment rods 68. Adjustment rods 68 can be constructed using 5/16-18 inch all thread that can be 7 inches long. Adjustment rods 68 can penetrate through a hole in processing component frame back 61 and can be secured in place with nuts 81 and nuts 82. Adjustment rods 68 can be adjusted using nuts 81 and nuts 82 and this can regulate tension in springs 66. Springs 66 can be connected to clevis pins 84 that can be inserted through a hole in pivoting upper fence sections 72. Tension in springs 66 can cause pivoting upper fence section stops 71 to rest against a fence stop 76. Regulation of tension in springs 66 can allow pivoting upper fence sections 72 to pivot and this can release material before it can become wedged underneath vertically adjustable lower fence sections 70 and possibly damage a patterned cross conveyor belt 14. Based on the disclosure provided herein, one of ordinary skill in the art will recognize that other dimensions, features, shapes, and/or constructions may be utilized to develop the aforementioned components in accordance with one or more embodiments of the present invention. For example, if increased or decreased productivity is required for processing component 60, it may be desirable to increase and/or decrease all dimensions and/or component quantities in order to increase or decrease the width of processing component 60.

FIG. 2C is a side view of processing component 60. In one particular case of the exemplary embodiment, processing component 60 can have a rectangular shape that can be created by welding together processing component frame sides 62, a processing component frame front 63 and a processing component frame back 61. Mounting tabs 74 can be welded perpendicular to processing component frame sides 62. Angle plates 78 can extend below processing component frame sides 62. Fence stop 76 can be welded perpendicular to processing component frame sides 62. Processing component shaft 64 can penetrate through processing component frame sides 62 and can be secured in place with set screws 83. Vertically adjustable lower fence sections 70 can be attached to the front of pivoting upper fence sections 72 with nuts and bolts 86. Clevis pins 84 can be inserted through holes in pivoting upper fence sections 72 and can be connected to springs 66 that can connect to adjustment rods 68 that can penetrate a processing component frame back 61 through holes and can be secured with nuts 81 and nuts 82. Again, based on the disclosure provided herein, one of ordinary skill in the art will recognize that other dimensions, features, shapes, and/or constructions may be utilized to develop the aforementioned components in accordance with one or more embodiments of the present invention.

FIG. 2D is a front view of processing component. In one particular case of the exemplary embodiment, processing component 60 can have a rectangular shape that can be created by welding together processing component frame sides 62 and a processing component frame front 63. Mounting tabs 74 can be welded perpendicular to processing component frame sides 62. Angle plates 78 can be welded in a front corner created by processing component frame sides 62 and a processing component frame front 63. Processing component shaft 64 can penetrate through a hole in processing component sides 62 and shaft collars 80 and bushings 85 and pivoting upper fence section sleeves 73 and can be secured using set screws 83 that can be located in shaft collars 80. Vertically adjustable lower fence sections 70 can be attached with nuts and bolts 86 to a front face of pivoting upper fence sections 72. Nuts and bolts 86 can connect vertically adjustable fence sections 70 and pivoting upper fence sections 72 using two 0.266 inch by 1.25 inch slots that can be located in a vertically adjustable lower fence sections 70 and two 0.266 inch holes that can be located in pivoting upper fence sections 72. Clevis pins 84 can be can be located in a 0.343 inch hole in pivoting upper fence sections 72. Pivoting upper fence section stops 71 can be welded perpendicular to a pivoting upper fence section 72. Again, based on the disclosure provided herein, one of ordinary skill in the art will recognize that other dimensions, features, shapes, and/or constructions may be utilized to develop the aforementioned components in accordance with one or more embodiments of the present invention.

FIG. 2E is a rear view of vertically adjustable lower sections 70 and pivoting upper sections 72 of processing component 60. In one particular case of the exemplary embodiment, nuts and bolts 86 can attach vertically adjustable lower fence section 70 to a front face of pivoting upper fence section 72. Bushings 85 can be inserted into ends of pivoting upper fence section sleeve 73. Pivoting upper fence section stops 71 can be welded vertically to pivoting upper fence section 72. Pivoting upper fence section sleeve 73 can be welded to pivoting upper fence section stops 71.

Small objects that encounter one or more of lower sections 70 can pass below the fence after initial contact or may be broken down to a particle size that can allow them to pass under the fence. A gap between lower sections 70 and patterned cross conveyor belt 14 determines a particle size that can be permitted to pass the fence after an initial contact or after processing occurs in a wave action that can be created directly in front of a fence. A resulting wave action is created when particles that are too large to pass under lower fence sections 70 repeatedly encounter a pattern present on patterned cross conveyor belt 14. Eventually, the size of large particles can be reduced to a size that can pass under a fence in a gap that can exist between the fence and patterned cross conveyor belt 14. Large particles that can not be reduced in size can remain in front of the fence and can eventually fall down inclined cross conveyor 12 and can accumulate in front of discharge regulator 90 and can be released into a waste pile if discharge regulator 90 is raised. Extremely large particles can remain in a material handler 10 if a gate at the rear of material handler 10 is adjusted to create a gap can not allow these extremely large particles to pass through to cross conveyor 12. A screening device could also be placed on top of material handler 10 and this could remove extremely large particles. Several methods could be used to pre-process material that could contain large or extremely large particles before placement of material in material handler 10 and processing with the present invention. In one particular case, a pattern on patterned cross conveyor belt 14 and a fence position that can be created by adjusting vertically adjustable lower fence sections 70 can create a gap that can range from 0.125 inch to 0.5 inch.

If a particle becomes wedged in a gap between patterned cross conveyor belt 14 and one of lower fence sections 70, upper fence sections 72 associated with the contacted lower fence sections 70 will pivot and allow the particle to pass beyond the fence. When the particle has passed, the tension in spring 66 can cause the fence section or sections to reposition into an original operating position. Allowing a particle to pass the fence in this manner can eliminate potential damage to patterned replacement belt 14 and other equipment that could occur if a particle was to remain wedged in a gap under the fence.

FIG. 2F is a side view of vertically adjustable lower fence sections 70 and pivoting upper fence sections 72 of processing component 60. In one particular case of the exemplary embodiment, nuts and bolts 86 can attach a vertically adjustable lower fence section 70 to a front face of pivoting upper fence section 72. Bushings 85 can be inserted into ends pivoting upper fence section stop 71. Processing component shaft 64 can be inserted through bushing 85. Pivoting upper fence section stops 71 can be welded vertically to pivoting upper fence section 72. Again, based on the disclosure provided herein, one of ordinary skill in the art will recognize that other dimensions, features, shapes, and/or constructions may be utilized to develop the aforementioned components in accordance with one or more embodiments of the present invention.

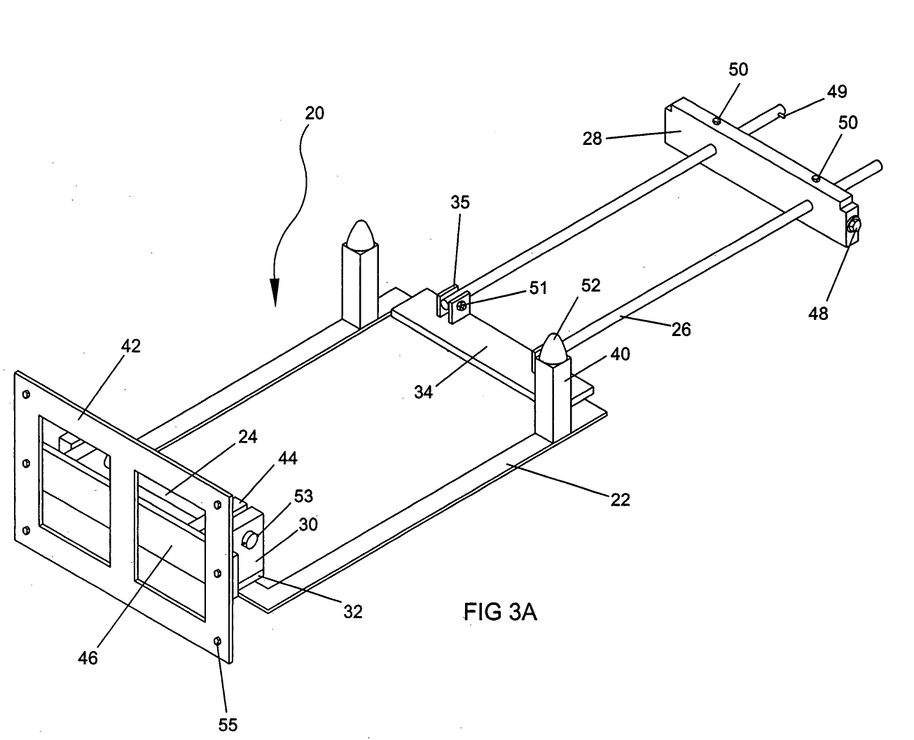

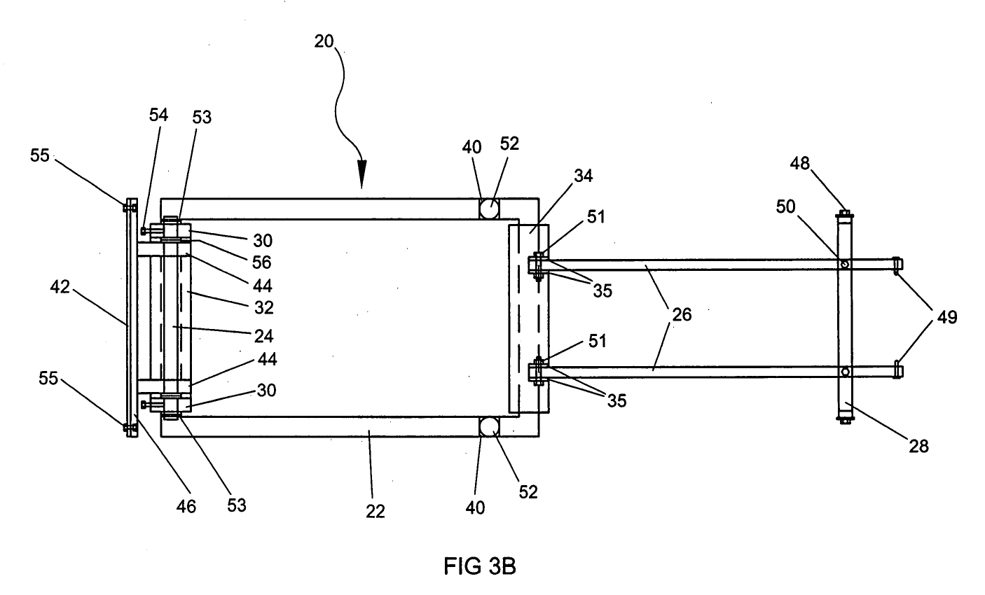

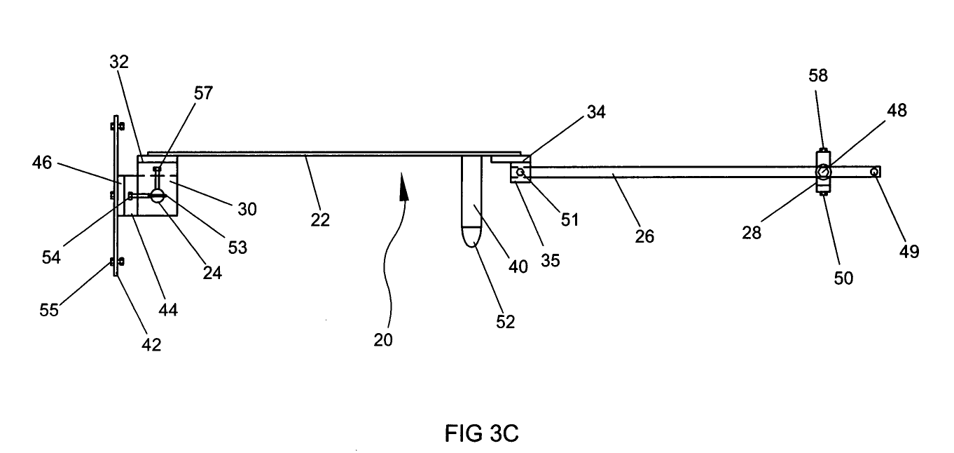

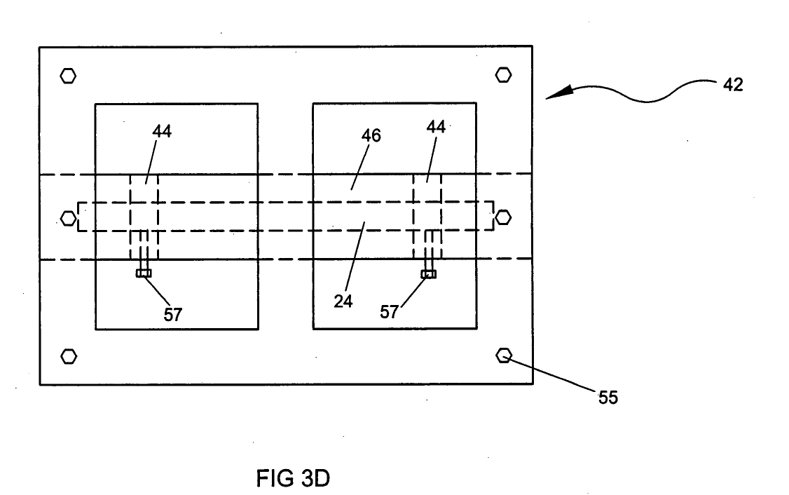

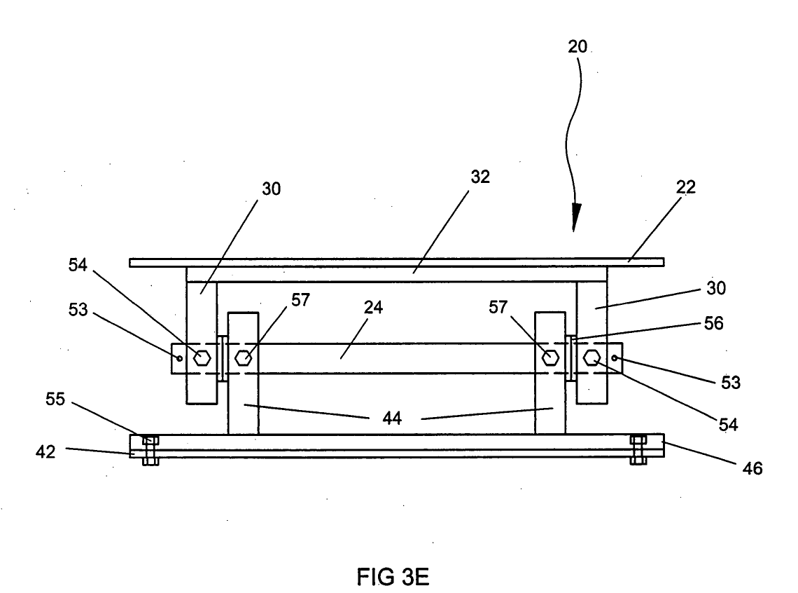

FIG. 3A provides a view of an incline component 20. In general, incline component 20 can provide an operational method for adjusting an elevation of a cross conveyor 12. As shown, incline component 20 can include a material handler attachment frame 22, a cross conveyor attachment frame 42, elevation adjustment rods 26, and an elevation pivot block 28, in accordance with some embodiments of the present invention. In one particular case of the exemplary embodiment, adjustment rod plate 34 can be welded flat on one end of material handler attachment frame 22. Adjustment rod connection tabs 35 can be welded perpendicular to adjustment rod plate 34 and can be connected to elevation adjustment rods 26 with nut and bolt 51. Elevation pivot block 28 can be positioned along elevation adjustment rod 26 and can be secured in place using bolts 50 that can tighten against elevation adjustment rods 26. Bolts 48 can thread into a hole on each end of elevation adjustment block 28 and can attach it to a cross conveyor 12. Pins 49 can prevent elevation pivot block 28 from traveling beyond the ends of elevation adjustment rods 26. Material handler attachment frame pivot end plate 32 can be welded flat to a material handler attachment frame 22. Material handler attachment frame pivot blocks 30 can be welded perpendicular to a material handler attachment frame pivot end plate 32. Shaft 24 can go through material handler attachment frame pivot blocks 30 and cross conveyor attachment frame pivot blocks 44. The ends of shaft 24 can be secured in place with roll pins 53. Cross conveyor attachment frame plate 46 is welded flat to cross conveyor attachment frame 42. Cross conveyor attachment frame pivot blocks 44 can be welded perpendicular to cross conveyor attachment frame plate 46. Nuts and bolts 55 can attach the cross conveyor attachment frame 42 to cross conveyor 12. Based on the disclosure provided herein, one of ordinary skill in the art will recognize that other dimensions, features, shapes, and/or constructions may be utilized to develop the aforementioned components in accordance with one or more embodiments of the present invention.

FIG. 3B is a view of incline component 20. In one particular case of the exemplary embodiment, incline component 20 can include a material handler attachment frame 22, a cross conveyor attachment frame 42, elevation adjustment rods 26, and an elevation pivot block 28. Material handler attachment frame 22 can be a rectangular, flat frame that can be constructed with 0.25 inch thick steel that can be 28.5 inches long and can be 17.75 inches wide. Material handler attachment frame 22 can attach to a material handler 10 equipped with a swivel kit, directly to a material handler, or to a material handler or other equipment using additional hardware. An adjustment rod plate 34 can be constructed with 0.5 inch thick steel that can be 3 inches wide and can be 14 inches long and can be welded flat to an end of a material handler attachment frame 22. Adjustment rod connection tabs 35 can be constructed with 0.25 inch thick steel that can be 1.5 inches by 1.5″ with a centered 0.344 inch hole and can be welded perpendicular to an adjustment rod plate 34. Nuts and bolts 51 can pass through a hole in adjustment rod connection tabs 35 and a 0.344″ hole in elevation adjustment rods 26. Elevation adjustment rods 26 can be constructed with 0.75 inch round steel that can be 28 inches long with a 0.25 inch hole 0.5″ from an end and a 0.344 inch hole 0.625 inch from another end. Adjustment rods 26 can pass through a 0.75 inch hole in an elevation pivot block 28 that can be constructed of 1 inch thick steel that can be 3 inches wide and can be 15 inches long and can have 0.5 inch by 0.5 inch notches in the corners of the same edge on opposite ends. Bolts 50 can be threaded into 0.312 inch holes that can be 5 inches from each end of elevation pivot block 28 and can tighten against elevation adjustment rods 26. Bolts 48 can thread into a 0.5 inch hole on each end of an elevation adjustment block 28 and can attach an elevation adjustment block 28 to a cross conveyor 12. Roll pins 49 can be used to prevent an elevation pivot block 28 from traveling beyond the ends of elevation adjustment rods 26. Leveling stops 40 can be constructed with 1.5 inch square steel tubing that can be 5.375 inches long and can be welded perpendicular to a material handler attachment frame 22 in a location that can be 3 inches from an end of a material handler attachment frame 22 where an adjustment rod plate 34 can be welded. Leveling stops 40 can have a rubber bumper 52 attached to the top. Rubber bumpers 52 can be cone shaped, and in one particular case are one inch high and one and one half inches in diameter. A material handler attachment frame pivot end plate 32 can be constructed with 0.5 inch thick steel that can be 3 inches wide and can be 14 inches long and can be welded flat to a material handler attachment frame 22. Material handler attachment frame pivot blocks 30 can be constructed with 1 inch thick steel that can be 3 inches wide and can be 4 inches long and can have a 1 inch hole that can be located 1.5 inches from the bottom and 1.5 inches from the side. Material handler attachment frame pivot blocks 30 can be welded 12 inches apart to a material handler attachment frame pivot end plate 32. Bolts 54 can be threaded through material handler attachment frame pivot blocks 30 and can tighten against shaft 24. Shaft 24 can be constructed with 1.0 inch round, solid steel that can be 16 inches long and can have 0.187 inch holes located 0.5 inch from each end. Ends of shaft 24 can be secured in place with roll pins 53. A shaft 24 can pass through material handler attachment frame pivot blocks 30 and washers 56 and cross conveyor attachment frame pivot blocks 44. Cross conveyor attachment frame pivot blocks 44 can be constructed of 1 inch thick steel that can be 3 inches wide and can be 4 inches long and can have a 1 inch hole located 1.5 inches from the bottom and 1.5 inches from a side and can be welded 3.25 inches from the ends of cross conveyor attachment frame plate 46. Cross conveyor attachment frame plate 46 can be constructed with 0.5 inch thick steel that can be 3 inches wide and can be 17.75 inches long. Cross conveyor attachment frame plate 46 can be welded flat to a cross conveyor attachment frame 42. A cross conveyor attachment frame 42 can be a rectangular, divided, flat frame that can be 17.75 inches by 12 inches. Cross conveyor attachment frame 42 can be constructed with five pieces of steel that can be welded together to form a flat, divided frame. Included in cross conveyor attachment frame 42 can be two side pieces that can be 0.25 inch thick steel that can be 2 inches wide and 17.75 inches long, two end pieces that can be 0.25 inch thick steel that can be 2 inches wide and 8 inches long, and a center piece that can be 0.25 inch thick steel that can be 2 inches wide and 8 inches long. Nuts and bolts 55 can be used to attach a cross conveyor attachment frame 42 to a cross conveyor 12. Based on the disclosure provided herein, one of ordinary skill in the art will recognize the dimensions, features, and/or shapes that may be utilized to incline component 20 in accordance with one or more embodiments of the present invention. For example, if increased or decreased productivity is required, it may be desirable to increase and/or decrease all dimensions and/or component quantities in order to increase or decrease the dimensions of incline component 20. Again, based on the disclosure provided herein, one of ordinary skill in the art will recognize that other dimensions, features, shapes, and/or constructions may be utilized to develop the aforementioned components in accordance with one or more embodiments of the present invention.

FIG. 3C is a side view of incline component 20 that can include a material handler attachment frame 22, a cross conveyor attachment frame 42, elevation adjustment rods 26, and an elevation pivot block 28, in accordance with some embodiments of these present invention. In one particular case of the exemplary embodiment, adjustment rod plate 34 can be welded flat on one end of material handler attachment frame 22. Adjustment rod connection tabs 35 can be welded perpendicular to adjustment rod plate 34 and can be connected to elevation adjustment rods 26 with nut and bolt 51. Elevation pivot block 28 can be positioned along elevation adjustment rod 26 and can be secured in place using bolts 50 and bolts 58 that can tighten against elevation adjustment rods 26. Bolts 48 can thread into each end of elevation adjustment block 28 and can attach it to a cross conveyor 12. Pins 49 can prevent elevation pivot block 28 from traveling beyond the ends of elevation adjustment rods 26. Material handler attachment frame pivot end plate 32 can be welded flat to a material handler attachment frame 22. Material handler attachment frame pivot blocks 30 can be welded perpendicular to a material handler attachment frame pivot end plate 32. Bolts 54 can thread through material handler attachment frame pivot blocks 30 and can tighten against shaft 24. Shaft 24 can go through material handler attachment frame pivot blocks 30 and cross conveyor attachment frame pivot blocks 44. The ends of shaft 24 can be secured in place with roll pins 53. Cross conveyor attachment frame plate 46 is welded flat to cross conveyor attachment frame 42. Cross conveyor attachment frame pivot blocks 44 can be welded perpendicular to cross conveyor attachment frame plate 46. Bolts 57 can be threaded through cross conveyor attachment frame pivot blocks 44 and can tighten against shaft 24. Nuts and bolts 55 can attach the cross conveyor attachment frame 42 to cross conveyor 12. Again, based on the disclosure provided herein, one of ordinary skill in the art will recognize that other dimensions, features, shapes, and/or constructions may be utilized to develop the aforementioned components in accordance with one or more embodiments of the present invention.

FIG. 3D is a bottom view of cross conveyor attachment frame 42 of incline component 20, in accordance with some embodiments of these present invention. In one particular case of the exemplary embodiment, cross conveyor attachment frame plate 46 can be welded flat against the cross conveyor attachment frame 42. Cross conveyor attachment frame pivot blocks 44 can be welded perpendicular to cross conveyor attachment frame plate 46. Bolts 57 can be threaded into cross conveyor attachment frame pivot blocks 44 and can tighten against shaft 24. Nuts and bolts 55 can attach cross conveyor attachment frame 42 to the cross conveyor 12. Again, based on the disclosure provided herein, one of ordinary skill in the art will recognize that other dimensions, features, shapes, and/or constructions may be utilized to develop the aforementioned components in accordance with one or more embodiments of the present invention.

FIG. 3E is an end view of material handler attachment frame 22 and cross conveyor attachment frame 42 of incline component 20. In one particular case of the exemplary embodiment, material handler attachment frame pivot end plate 32 can be welded flat to material handler attachment frame 22. Material handler attachment frame pivot blocks 30 can be welded perpendicular and on the ends of material handler attachment frame pivot end plate 32. Bolts 54 can be threaded into material handler attachment frame pivot blocks 30 and can tighten against shaft 24. Cross conveyor attachment frame plate 46 can be welded flat to cross conveyor attachment frame 42. Cross conveyor attachment frame pivot blocks 44 can be welded perpendicular to a cross conveyor attachment frame plate 46. Bolts 57 can be threaded into cross conveyor attachment frame pivot blocks 44 and can tighten against shaft 24. Nuts and bolts 55 can attach cross conveyor attachment frame 42 to cross conveyor 12. Shaft 24 can go through cross conveyor attachment frame pivot blocks 44 and material handler attachment frame pivot blocks 30. Washers 56 can be placed on shaft 24 and can be between cross conveyor attachment frame pivot blocks 44 and material handler attachment frame pivot blocks 30. The end of shaft 24 can be secured in place with roll pins 53. Again, based on the disclosure provided herein, one of ordinary skill in the art will recognize that other dimensions, features, shapes, and/or constructions may be utilized to develop the aforementioned components in accordance with one or more embodiments of the present invention.

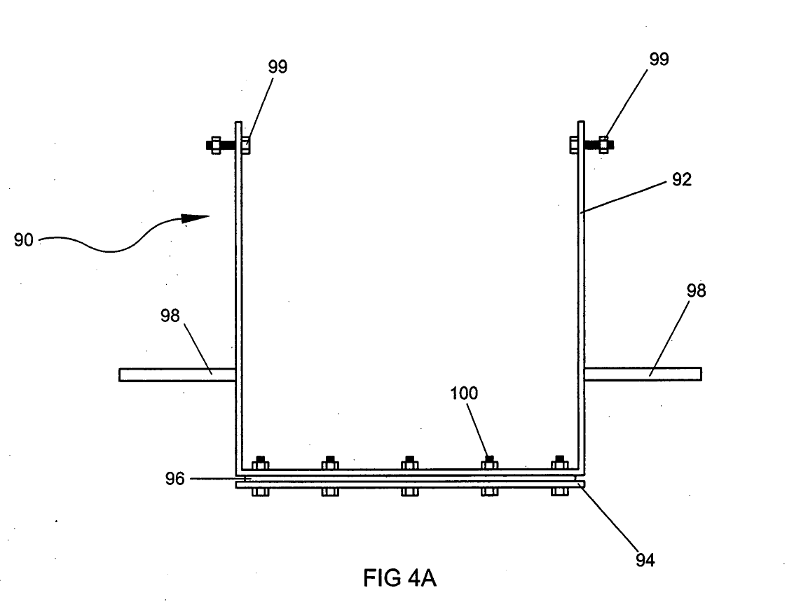

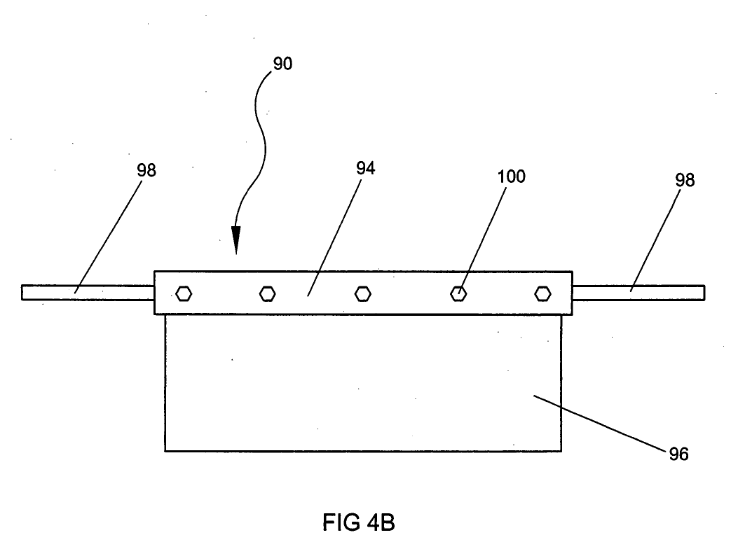

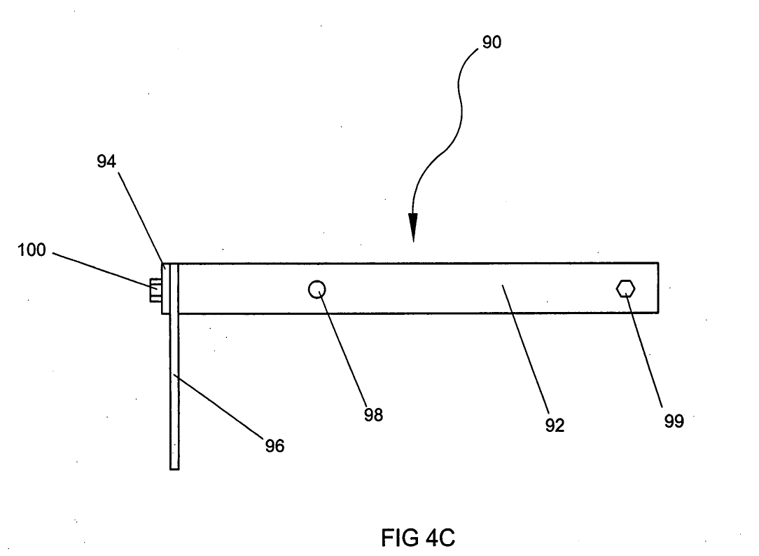

FIG. 4A is a top view of a discharge regulator 90 in accordance with some embodiments of the present invention. In general, discharge regulator 90 can provide an operational method for discharging waste material from a cross conveyor 12. In one particular case of these exemplary embodiments, discharge regulator frame 92 can be ‘U’ shaped and can have an end that can be constructed with 0.25 inch thick steel that can be 1.5 inches wide and can be 14.75 inches long. Discharge regulator frame 92 can have sides that can be constructed with 0.25 inch thick steel that can be 1.5 inches wide and can be 14.75 inches long. Three pieces that can be used to construct discharge regulator frame 92 can be welded together to create the ‘U’ shape. A 0.265 inch hole can be located on the sides 1 inch from the open end of the ‘U’ shaped discharge regulator frame 92 and 0.75 inch from an edge of the discharge regulator frame 92. Nuts and bolts 99 can be inserted through a hole and can be used to attach discharge regulator frame 92 to a cross conveyor 12. Rods 98 can be constructed with 0.5 inch round, solid steel that can be 5 inches long. Rod 98 can be inserted into a 0.5 inch hole in a discharge regulator frame 92 and welded perpendicular to discharge regulator frame 92. Nuts and bolts 100 can secure a discharge regulator plate 94 and a rubber sheet 96 to a discharge regulator frame 92. Discharge regulator plate 94 can be constructed with 0.25 inch steel that can be 1.5 inches wide and can be 14.75 inches long and can have five 0.265 inch holes that can be located 1 inch, 4.25 inches, 7.375 inches, 10.625, and 13.75 inches from an end. Discharge regulator frame 92 can have five 0.265 inch holes that can be located 1 inch, 4.25 inches, 7.375 inches, 10.625, and 13.75 inches from one side and that can align with holes in discharge regulator plate 94. Rubber sheet 96 can be 0.25 inch thick rubber and can be 6.25 inches high and can be 14 inches wide. Based on the disclosure provided herein, one of ordinary skill in the art will recognize the dimensions, features, and/or shapes that may be utilized to develop discharge regulator 90 in accordance with one or more embodiments of the present invention. For example, if increased or decreased productivity is required for processing component 60, it may be desirable to increase and/or decrease all dimensions and/or component quantities in order to increase or decrease the width of discharge regulator 90. Based on the disclosure provided herein, one of ordinary skill in the art will recognize that other dimensions, features, shapes, and/or constructions may be utilized to develop the aforementioned components in accordance with one or more embodiments of the present invention.

FIG. 4B is an end view of discharge regulator 90, in accordance with some embodiments of the present invention. In one particular case of the exemplary embodiment, rods 98 can be welded perpendicular to a discharge regulator frame 92. Rubber sheet 96 can be secured in place between a discharge regulator plate 94 and a discharge regulator frame 92 with nuts and bolts 100. Again, based on the disclosure provided herein, one of ordinary skill in the art will recognize that other dimensions, features, shapes, and/or constructions may be utilized to develop the aforementioned components in accordance with one or more embodiments of the present invention.

FIG. 4C is a side view of discharge regulator 90, in accordance with some embodiments of the present invention. In one particular case of the exemplary embodiment, rods 98 can be welded perpendicular to a discharge regulator frame 92. Rubber sheet 96 is secured in place between a discharge regulator plate 94 and a discharge regulator frame 92 with nuts and bolts 100. Nuts and bolts 99 can attach a discharge regulator frame 92 to a cross conveyor 12. Based on the disclosure provided herein, one of ordinary skill in the art will recognize that other dimensions, features, shapes, and/or constructions may be utilized to develop the aforementioned components in accordance with one or more embodiments of the present invention.

Some of the methods in accordance with the present invention provide for retrofitting existing equipment to operate in accordance with one or more embodiments of the present invention. Such retrofitting may include replacing a manufacturer installed cross conveyor belt associated with cross conveyor 12 with a patterned cross conveyor belt 14. Processing component 60 can be attached at an end of cross conveyor 12 using nuts and bolts that can be used in conjunction with mounting tabs 74 and holes that can be drilled in a cross conveyor 12. A cross conveyor attachment frame 42 can be attached to a location in or near the middle of a cross conveyor 12. Nuts and bolts 55 can be used in conjunction with holes in cross conveyor attachment frame 42 and holes that can be drilled in a cross conveyor 12 to attach a cross conveyor attachment frame 42 to a cross conveyor 12. A discharge regulator 90 can be installed at an end of a cross conveyor 12. Nuts and bolts 99 can be used in conjunction with holes drilled in a cross conveyor 12 and holes in a discharge regulator frame 92 to attach a discharge regulator 90. An elevation pivot block 28 can be attached to a cross conveyor 12 with bolts 48 that can be inserted through holes drilled in a cross conveyor 12 and threaded into an elevation pivot block 28. Bolts 50 and bolts 58 and bolts 57 and bolts 54 can be loosened so elevation rods 26 can slide through an elevation pivot block 28 and rubber bumpers 52 can come to rest against a cross conveyor 12 and a material handler attachment frame 22 can be in a position parallel to a cross conveyor 12. Material handler attachment frame 22 can be attached to a material handler 10 that can be equipped with a swivel kit using material handler attachment hardware and/or other suitable hardware. Nuts and bolts 86 can be used to place vertically adjustable lower fence sections 70 in an optimal operating position relative to patterned cross conveyor belt 14. Placing vertically adjustable lower fence sections 70 in an optimal operating position can influence a particle size of a processed material that can pass through a processing component 60.

Other methods in accordance with embodiments of the present invention provide for processing using the equipment in accordance with embodiments of the present invention. The processing preparation procedures can include positioning the equipment by raising an end of a cross conveyor 12 where a processing component 60 can be attached. Raising this end of a cross conveyor 12 can allow elevation rods 26 to move through an elevation pivot block 28. An optimal operational position for a cross conveyor 12 can be a position that can place a cross conveyor 12 at a 45 degree angle relative to ground. When an optimal operational angle for a cross conveyor 12 can be obtained, bolts 50 and bolts 58 and bolts 57 and bolts 54 can be tightened. A proper operating position can be maintained by tightening bolts 50 and bolts 58 and bolts 57 and bolts 54.

When a material is processed, a tractor or another suitable power source can be connected to a material handler 10. A cross conveyor 12 can be oriented so it can point directly behind a material handler 10. Material can be placed in a material handler 10. Controls associated with a material handler 10 can be used to put a material handler's belt in motion and can be used to put a patterned cross conveyor belt 14 in motion. When belts associated with cross conveyor 12 and material handler 10 can be put in motion, material can be deposited onto a patterned cross conveyor belt 14 from a material handler 10. In some cases, material handler 10 is equipped with a swivel kit 21. A patterned cross conveyor belt 14 can move the material up an inclined cross conveyor 12 to a processing component 60. At this location, material can contact vertically adjustable lower fence sections 70 and processing can occur. A desirable processed material can pass beyond processing component 60 to a pile. Waste material can be retained in front of a processing component 60 and can eventually fall down an inclined cross conveyor 12 and can be discharged to a separate pile when a discharge regulator 90 can be raised.

In conclusion, the present invention provides novel systems, methods and arrangements for handling material. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A system for sorting materials, the system comprising:
a material handler mounting component, wherein the material handler mounting component is tailored for connection to a material handler;
a cross conveyor, wherein the cross conveyor is connected to the material handler mounting component, and wherein the cross conveyor includes a first end and a second end;
an elevation adjustment device, wherein the elevation adjustment device is connected to the cross conveyor, and wherein the elevation adjustment device is operable to allow modification of the elevation of the first end of the cross conveyor in relation to the elevation of the second end of the cross conveyor; and
a processing device, wherein the processing device is attached to the cross conveyor near the first end of the cross conveyor.

2. The system of claim 1, the system further comprising:
a material handler.

3. The system of claim 1, wherein the processing device includes:
a rectangular box; and
a pivoting fence attached to the rectangular box, wherein the pivoting fence includes at least one pivot section.

4. The system of claim 4, wherein the pivoting fence includes a plurality of pivot sections.

5. The system of claim 4, wherein the pivot section is formed of steel.

6. The system of claim 4, wherein the rectangular box is formed of steel.

7. The system of claim 4, wherein the pivot section includes an upper pivot section and a lower pivot section, and wherein the lower pivot section is adjustable such that a space between the lower pivot section and a conveyor belt associated with the cross conveyor may be adjusted.

8. The system of claim 1, wherein the system further comprises:
a discharge regulator attached to the cross conveyor near the second end of the cross conveyor.

9. The system of claim 1, wherein the system further comprises:
a power connector, wherein the power connector is operable to draw power from the material handler for operation of at least the elevation adjustment device.

10. The system of claim 10, wherein the power connector is a hydraulic connector.

11. The system of claim 1, wherein the system further comprises:
a patterned conveyor belt associated with the cross conveyor.

12. The system of claim 11, wherein the processing device is operable to reduce the number of large particles from material conveyed to the processing device on the conveyor belt.

13. A method for retrofitting material handling equipment, the method comprising:
providing a cross conveyor;
providing a processing device;
replacing a smooth belt associated with the cross conveyor with a patterned cross conveyor belt; and
attaching the processing device to the cross conveyor.

14. The method of claim 13, wherein the method further comprises:
attaching the cross conveyor to a material handler.

15. The method of claim 13, wherein the processing device includes:
a rectangular box; and
a pivoting fence attached to the rectangular box, wherein the pivoting fence includes a plurality of pivot sections.

16. A system for soil processing, the system comprising:
a cross conveyor, wherein the cross conveyor includes a conveyor belt supported by a cross conveyor frame, and wherein the cross conveyor includes a first end and a second end;
a swivel kit, wherein the swivel kit is operable to attach the cross conveyor to a material handler, and wherein the swivel kit includes a funnel operable to receive material from a material handler and transfer the material to the conveyor belt; and
a processing device, wherein the processing device is attached to the cross conveyor near the first end of the cross conveyor, and wherein the processing device is operable to eliminate large particles from the material.

17. The system of claim 16, wherein the system further comprises:
an elevation adjustment device, wherein the elevation adjustment device is connected to the cross conveyor, and wherein the elevation adjustment device is operable to allow modification of the elevation of the first end of the cross conveyor in relation to the elevation of the second end of the cross conveyor.

18. The system of claim 17, wherein the processing device includes:
a rectangular box; and
a pivoting fence attached to the rectangular box, wherein the pivoting fence includes at least one pivot section.

19. The system of claim 18, wherein the pivot section includes an upper pivot section and a lower pivot section, and wherein the lower pivot section is adjustable such that a space between the lower pivot section and the conveyor belt may be adjusted.

20. The system of claim 16, wherein the system further comprises:
a power connector, wherein the power connector is operable to draw power from the material handler for operation of at least the conveyor belt.
